(19) United States
(12) Patent Application Publication
(10) Pub. No.: US 2026/0185341 A1
(43) Pub. Date: Jul. 2, 2026

(54) BIDET

(71) Applicant: COWAY CO., LTD., Gongju-si (KR)

(72) Inventors: Young Ju KIM, Seoul (KR); Seoung Eun LIM, Seoul (KR); Sung Hee LEE, Seoul (KR)

(73) Assignee: COWAY CO., LTD., Gongju-si (KR)

(21) Appl. No.: 19/320,413

(22) Filed: Sep. 5, 2025

(30) Foreign Application Priority Data
Dec. 27, 2024 (KR) 10-2024-0199125

(51) Int. Cl. E03D 9/08; E03D 9/052

(52) U.S. Cl. CPC E03D 9/08; E03D 9/052

(57) ABSTRACT

The present invention relates to a bidet. The bidet according to an embodiment of the present invention may include an intake port and an exhaust port, which are formed in a bidet body; a filter installed on a flow path between the intake port and the exhaust port; a fan configured to generate a flow of fluid toward the exhaust port from the intake port; a storage container, of which at least a part is disposed to overlap the flow path and which accommodates a spray material; a spray material discharging portion configured to discharge the spray material stored in the storage container to an outside; and a controller configured to control an operation of the fan and discharging of the spray material through the spray material discharging portion.

### TECHNICAL FIELD

The present disclosure relates to a bidet.

### BACKGROUND ART

A bidet is a device that is installed on a toilet bowl and can automatically perform anus washing and female local washing by spraying washing water through a nozzle provided in a bidet body part.

When flushing the toilet after use, aerosol may be dispersed, or the foul odor of the toilet may spread, which may cause hygiene problems and user discomfort.

As related art for solving the above-described problems, Korean Patent Registration No. 10-2515730 discloses a bidet having antibacterial, deodorizing and ventilation functions. This relates to a bidet in which odorous air sucked in by fan movement passes through a filter and becomes antibacterial and deodorized by the filter, but there is a limitation in that the bidet cannot emit the odor of the space in which the bidet is installed.

Korean Patent Registration No. 10-2339402 relates to a spray-type toilet sterilizer and discloses a configuration in which a chemical is sprayed toward the inside of a toilet bowl when a switch provided on a toilet seat cover is pressed. However, the spray-type toilet sterilizer causes inconvenience in that manual operation by a user is required, and since the spray-type toilet sterilizer adopts a configuration in which an already generated bad odor is covered with a fragrance by the chemical rather than being removed, the spray-type toilet sterilizer may cause more discomfort to the user in some cases.

### PRIOR-ART DOCUMENT

### Patent Document

(Patent Document 1) Korean Patent Registration No. 10-2515730 (Mar. 27, 2023)

(Patent Document 2) Korean Patent Registration No. 10-2339402 (Dec. 9, 2021)

### DISCLOSURE

### Technical Problem

According to the present disclosure, the present disclosure provides a bidet in which the odorous air in an environment where a bidet is installed, is deodorized and the deodorized air can be provided to a user and thus hygiene and cleanliness can be enhanced.

The present disclosure also provides a bidet in which not only odorous substances contained in the odorous air are deodorized, but also odor-containing odor-emitting substances can be together discharged to the outside so that hygiene and cleanliness can be enhanced and user satisfaction can be increased.

The present disclosure also provides a bidet in which an exhaust port is formed in a location where the air discharged through the exhaust port does not directly contact the user, so that discomfort caused by the user's contact with the discharged air can be minimized.

The present disclosure also provides a bidet, which is configured to discharge a spray material toward the outside of a toilet bowl or bidet and is excellent in removing odors while performing sterilization inside the toilet bowl and/or sterilization of the environment in which the bidet is installed.

### Technical Solution

According to an aspect of the present disclosure, there is provided a bidet including an intake port and an exhaust port, which are formed in a bidet body; a filter installed on a flow path between the intake port and the exhaust port; a fan configured to generate flow of a fluid toward the exhaust port from the intake port; a storage container, of which at least a part is disposed to overlap the flow path and which accommodates a spray material; a spray material discharging portion configured to discharge the spray material stored in the storage container toward an outside; and a controller configured to control an operation of the fan and the discharging of the spray material through the spray material discharging portion.

The fan may be provided with a single unit, and the controller may be configured to control a rotation speed of the fan.

When user seating is detected, the controller may control an operation of the spray material discharging portion so that the spray material is discharged toward a toilet bowl.

The controller may control the fan to rotate at a first rotation speed while user
seating is detected, and may control the fan to rotate at a second rotation speed when departure from a seat is detected after user seating, and the second rotation speed may be faster than the first rotation speed.

The intake port may include a first intake port and a second intake port, which are formed in different positions of the bidet body, and the flow path may include a first flow path between the first intake port and the exhaust port and a second flow path between the second intake port and the exhaust port, and the fan may include a first fan installed on the first flow path and a second fan installed on the second flow path.

The first fan and the second fan may be fans that rotate at a constant speed, but the rotation speed of the first fan may be slower than the rotation speed of the second fan, and the controller may control the first fan to operate while user seating is detected, and may control only the second fan to operate when departure from a seat after user seating is detected.

The first fan and the second fan may be fans that rotate at a constant speed, but the rotation speed of the first fan may be slower than the rotation speed of the second fan, and the controller may control the first fan to operate while user seating is detected, and may control all of the first fan and the second fan when departure from a seat after user seating is detected.

The exhaust port may include a plurality of exhaust holes that pass through a lower surface of the bidet body.

The intake port may include a plurality of intake holes that pass through a lower surface of the bidet body.

The storage container may include an inlet through which the spray material is introduced into the storage container, and a stopper, which covers the inlet and is configured to contact the spray material accommodated in the storage container and contain the spray material.

The stopper may be disposed to communicate with the flow path, and as the fan operates, the spray material contained in the stopper may be discharged to an outside through the exhaust port.

The spray material discharging portion may include a spray nozzle, and a pump provided between the storage container and the nozzle and configured to press the spray material toward the spray nozzle from the storage container.

The bidet may further include a washing unit that provides a fluid, in which raw water flowing in from an outside is pre-treated, as washing water to a user, and the spray material discharging portion may include a spray nozzle and a mixing line, which are provided between the storage container and the nozzle and of which at least a part communicates with a raw water inflow line.

### Advantageous Effects

In a bidet according to the present disclosure, the odorous air in an environment where the bidet is installed, is deodorized and the deodorized air can be provided to a user so that hygiene and cleanliness can be enhanced.

In addition, not only can odorous substances contained in the odorous air be deodorized, but odor-containing, odor-emitting substances can also be together discharged to the outside, so that hygiene and cleanliness can be enhanced, and simultaneously fragrance is naturally spread into a bathroom space, thus increasing user satisfaction.

In addition, an exhaust port is formed in a location where the air discharged through the exhaust port does not directly contact the user, so that discomfort caused by the user's contact with the discharged air can be minimized.

In addition, since the bidet is configured to discharge a spray material toward the outside of a toilet bowl or bidet, sterilization inside the toilet bowl and/or sterilization of the environment in which the bidet is installed can be performed, and the bidet is excellent in removing odors.

### BRIEF DESCRIPTION OF THE DRAWING

FIG. 1 is a diagram illustrating a state where a bidet according to an embodiment of the present disclosure is installed on a toilet bowl.

FIGS. 2 and 3 are diagrams for explaining configurations installed inside a bidet body of the bidet according to an embodiment of the present disclosure.

FIG. 4 is a schematic block diagram for explaining a bidet according to an embodiment of the present disclosure.

FIG. 5 is a schematic block diagram for explaining a bidet according to another embodiment of the present disclosure.

### MODE OF THE INVENTION

In some cases, in order to avoid ambiguity in the concept of the present disclosure, known structures and devices may be omitted or illustrated in block diagram form focusing on the core functions of each structure and device.

Throughout the specification, when a part is said to “comprising” a certain component, this does not mean excluding other components unless specifically stated otherwise, but rather that other components may be included. In addition, terms such as “part”, “unit”, and “module” described in the specification mean a unit that processes at least one function or operation, which may be implemented by hardware or software, or a combination of hardware and software. In addition, “a (or an)”, “one”, “the”, and similar related words may be used in the context of describing the present disclosure (especially in the context of the claims below) to include both singular and plural meanings, unless otherwise indicated in the specification or clearly contradicted by the context. In describing embodiments of the present disclosure, if it is judged that a detailed description of a known function or configuration may unnecessarily obscure the gist of the present disclosure, the detailed description will be omitted. In addition, the terms described below are terms defined in consideration of functions in the embodiments of the present disclosure, and these may vary depending on the intention or custom of the user or operator. Thus, the definitions should be made based on the contents throughout this specification.

Hereinafter, the present disclosure will be described in detail with reference to the accompanying drawings.

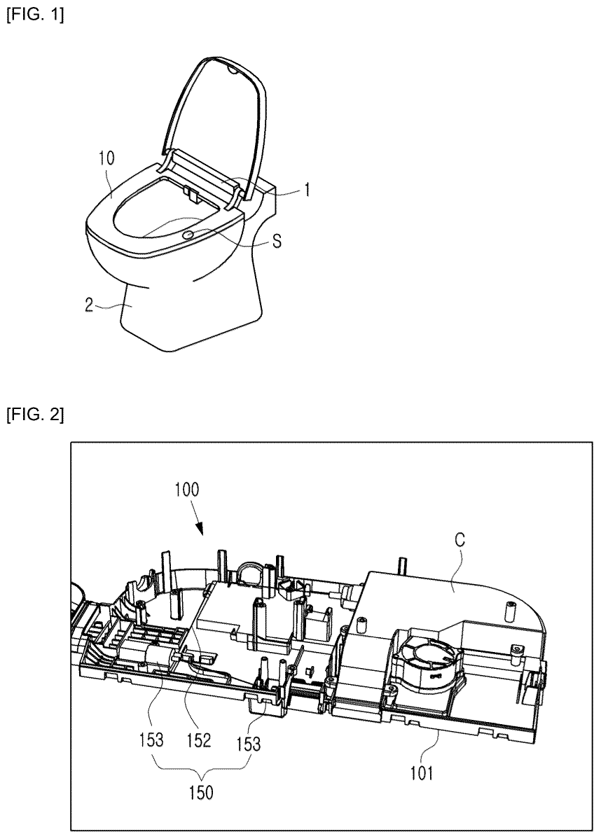

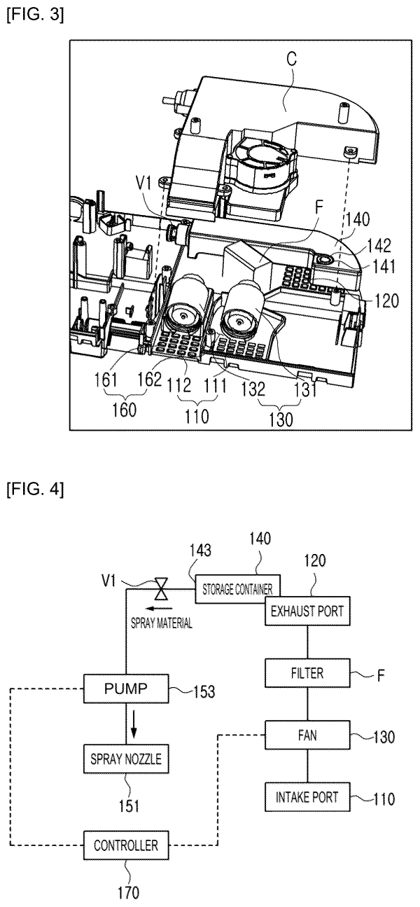

First, a bidet 1 according to an embodiment of the present disclosure will be described in detail with reference to FIGS. 1 through 3. FIG. 1 is a diagram illustrating a state where a bidet according to an embodiment of the present disclosure is installed on a toilet bowl, and FIGS. 2 and 3 are diagrams for explaining configurations installed inside a bidet body of the bidet according to an embodiment of the present disclosure.

Referring to FIG. 1, the bidet 1 according to an embodiment of the present disclosure may be installed on a toilet bowl 2, and may include a toilet seat 10 that is rotatable with respect to the toilet bowl 2. The toilet seat 10 is a portion that the user's buttocks come into contact with, and a toilet seat heater may be installed on the toilet seat 10, and a seat sensor S for detecting user seating may be installed in the toilet seat 10. When the toilet seat heater operates, the toilet seat 10 may be heated according to a set temperature so as to provide warmth to the user, and controlling of different operations may be performed by a controller 170 depending on whether user seating is detected by the seat sensor S.

Referring to FIGS. 2 through 5, the bidet 1 may include a bidet body 100 in which configurations for performing a bidet function are installed, and the bidet body 100 may include an intake port 110, an exhaust port 120, a fan 130, a storage container 140, a spray material discharging portion 150, a flow path 160, and a controller 170.

The intake port 110 and the exhaust port 120 may each be configured to pass through a lower surface 101 of the bidet body 100.

Specifically, the intake port 110 may include a plurality of intake holes that pass through the front lower surface 101 of the bidet body 100, and the exhaust port 120 may include a plurality of exhaust holes that pass through the rear lower surface 101 of the bidet body 100.

The front lower surface 101 of the bidet body 100 may be a portion that comes into contact with the internal space of the toilet bowl 2, and thus, odors in the internal space of the toilet bowl 2 may be introduced through the intake port 110 passing through the front lower surface 101.

Meanwhile, the exhaust port 120 is formed on the rear lower surface 101 of the bidet body 100 so that the air discharged through the exhaust port 120 may not come into direct contact with the user. In addition, the exhaust port 120 is formed on the rear lower surface 101 so that moisture flowing into the exhaust port 120 from the outside may be minimized.

The fan 130 may be arranged on the flow path 160 between the intake port 110 and the exhaust port 120. When the fan 130 operates, a fluid flow occurs from the intake port 110 toward the exhaust port 120.

A filter F may be disposed in the flow path 160, and more particularly, the deodorizing filter F may be disposed in front of or behind the fan 130. When the fan 130 operates, the odorous air introduced through the intake port 110 passes through the filter F, becomes antibacterial and deodorized, and the antibacterial and deodorized air may be discharged to the outside through the exhaust port 120.

In an embodiment of the present disclosure, the fan 130 may be provided with a single unit that may control the speed. When the fan 130 rotates, noise may occur, and the controller 170 to be described later may remove odorous air inside the toilet bowl 2 while minimizing the noise felt by the user, by controlling the rotation speed of the fan 130.

More specifically, in case of the bidet 1 including the fan 130 provided with the single number, the controller 170 controls the fan 130 to rotate at a first rotation speed while user seating is detected, and controls the fan 130 to rotate at a second rotation speed when departure from the seat is detected, after user seating. Here, the second rotation speed may be faster than the first rotation speed.

While user seating is detected, the fan 130 is controlled to rotate at a relatively low speed so that noise caused by the fan 130 in the process of using the toilet may be minimized (noise from the fan is proportional to the rotation speed of the fan), and after departure from the seat is detected, the fan 130 is controlled to rotate at a relatively high speed so that problems such as aerosol dispersion and spread of fecal odor when flushing can be quickly resolved.

Meanwhile, in another embodiment of the present disclosure, the fan 130 may include two or more fans that rotate at a constant speed. More specifically, in an embodiment including two or more fans 130, the two or more fans 130 may be formed at the first intake port 111 and the second intake port 112 in different positions of the bidet body 100, and the flow path 160 may include a first flow path 161 between the first intake port 111 and the exhaust port 120 and a second flow path 162 between a second intake port 112 and the exhaust port 120. The first fan 131 may be disposed on the first flow path 161, and the second fan 132 may be disposed on the second flow path 162. The first flow path 161 and the second flow path 162 may join at one point, and the filter F may be located at the rear end of a joining point, so that air flowing along the first flow path 161 or the second flow path 162 may reach the filter F.

The first fan 131 and the second fan 132 may be fans that rotate at a constant speed, and specifically, the rotation speed of the first fan 131 may be slower than the rotation speed of the second fan 132. However, the present disclosure is not specifically limited thereto, and an embodiment in which the rotation speed of the second fan 132 is slower than the rotation speed of the first fan 131, also belongs to the scope of the present disclosure.

In the case of the bidet 1 including a plurality of fans, the controller 170 controls a fan having a slower rotation speed (for example, a first fan) to operate while user seating is detected, and a fan having a faster rotation speed (for example, a second fan) or all fans to operate when departure from the seat is detected after user seating.

The fan that rotates at a slower speed is controlled to operate while user seating is detected, so that noise caused by the fan 130 in the process of using the toilet may be minimized, and the fan that rotates at a faster speed is controlled to operate after departure from the seat is detected, or all fans are controlled to operate so that problems such as aerosol spread and the spread of the foul odor of the toilet that occurs when flushing the toilet may be quickly resolved.

The storage container 140 may be disposed such that at least a part of the storage container 140 overlaps the flow path 160.

Specifically, a spray material is stored in the storage container 140, and an inlet 141 through which the spray material is introduced into the storage container 140, and a stopper 142 for covering the inlet 141 may be provided at one side of the storage container 140.

The stopper 142 may be formed of, for example, a material that may contain a certain amount of the spray material. That is, the stopper 142 may serve as a stick for a diffuser. When supplementation of spray material into the storage container 140 is required, the spray material may be supplemented by opening the stopper 142 and introducing the spray material through the inlet 141.

In an embodiment of the present disclosure, the stopper 142 may communicate with the flow path 160.

When the fan 130 operates, a flow of fluid occurs from the intake port 110 toward the exhaust port 120, and in this process, the spray material contained in the stopper 142 may be together discharged to the outside through the exhaust port 120. In other words, when the fan 130 operates, the odorous air introduced into the intake port 110 becomes antibacterial and is deodorized by the filter F, and the spray material contained in the stopper 142 is mixed with the antibacterial and deodorized air, and the mixed air is discharged through the exhaust port 120, so that not only is the antibacterial and deodorized air supplied into a space where the bidet 1 is installed, but the air including the fragrance of the spray material may also be provided into the space where the bidet 1 is installed. Thus, user satisfaction may be enhanced.

The spray material discharging portion 150 is configured to discharge the spray material stored in the storage container 140 to the outside.

Specifically, the spray material discharging portion 150 may include a spray nozzle 151, a pump 152, and a spray material flow path 153.

The spray material flow path 153 connects a discharge port 143 of the storage container 140 to the spray nozzle 151, and the pump 152 may be installed on the spray material flow path 153 and may press the spray material from the storage container 140 toward the spray nozzle 151. That is, when the pump 152 operates, the spray material stored in the storage container 140 may be discharged to the outside of the bidet body 100 through the spray nozzle 151. Referring to FIG. 4, a check valve V1 is installed at the discharge port 143 of the storage container 140, and only the movement of the spray material from the discharge port 143 toward the spray nozzle 151 may be allowed, and the movement of the spray material from the discharge port 143 toward the storage container 140 may be blocked.

In an example, the spray nozzle 151 may be disposed to face the inner side of the toilet bowl 2 so that the spray material may be discharged to the inner side of the toilet bowl 2, but the spray nozzle 151 may also be disposed to face the outer side of the bidet body 100 so that the spray material may be discharged to an environment where the bidet 1 is installed.

In the bidet 1 according to another embodiment of the present disclosure, the spray material discharging portion 150 may be connected to an electrolytic sterilizing water providing portion that provides electrolytic sterilizing water or a bubble detergent providing portion that provides bubble detergent, and the electrolytic sterilizing water and/or the bubble detergent may also be discharged to the outside through the spray nozzle 151.

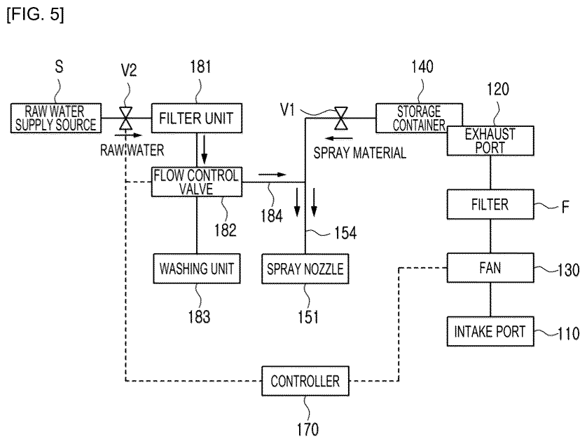

In the bidet 1 according to another embodiment of the present disclosure, the spray material may be mixed with washing water, and the mixed material may be discharged to the outside through the spray nozzle 151. This will be described in more detail with reference to FIG. 5.

Referring to FIG. 5, the bidet 1 according to another embodiment of the present disclosure may include a filter unit 181 that removes foreign substances from the fluid introduced from a raw water supply source S, a flow control valve 182 that controls flow and water supplied to a washing unit 183 according to commands input from the outside, and the washing unit 183 that discharges the washing water toward the user.

A raw water control valve V2 may be disposed between the raw water supply source S and the filter unit 181, and when the raw water control valve V2 is opened, the washing water may be discharged through the washing unit 183.

When a command to discharge the spray material is input, the controller 170 may open the raw water control valve V2 and may control the flow control valve 182 to switch to the side of the spray nozzle 151. In this case, the fluid that passes through the filter unit 181 and the flow control valve 182 is introduced into a mixing line 154 connected to the spray nozzle 151, and the spray material stored in the storage container 140 may also be pumped into the mixing line 154 and mixed with the fluid due to raw water pressure. Thus, the spray material and the fluid (washing water) may be mixed with each other and discharged to the outside through the spray nozzle 151.

An operating method of the bidet 1 according to an embodiment of the present disclosure as described above will be described in detail.

When the user sits on the toilet seat 10 so as to use the toilet, seating may be detected by the seat sensor S. When seating is detected, the controller 170 may control the fan 130 to operate. In an embodiment in which a single fan is provided, the controller 170 may control the fan 130 to rotate at a first speed. In an embodiment in which a plurality of fans is provided, the controller 170 may control a fan having a slower rotation speed to operate. Thus, a kind of negative pressure may be formed in the inner space of the toilet bowl 2 so that air including an odor may be introduced through the intake port 110 other than the user side and thus a situation where odorous air approaches the user, may be completely prevented. Furthermore, the odorous air introduced through the intake port 110 becomes antibacterial and is deodorized, and while the antibacterial and deodorized air is discharged through the exhaust port 120, the spray material contained in the stopper 142 may be together discharged to the outside. Thus, the user may be provided with air that is free of odors and further contains a fragrance. In addition, even when the water in the toilet bowl is flushed out as the fan 130 operates, the problem of aerosol dispersion may be prevented.

Furthermore, when seating is detected, the controller 170 may control the spray material stored in the storage container 140 to be discharged to the outside through the spray nozzle 151. In an embodiment in which the pump 152 is provided, the pump 152 may be controlled to operate, and the spray material stored in the storage container 140 may be controlled to be discharged to the outside of the toilet bowl 2 or the bidet 1 through the spray nozzle 151. In addition, in an embodiment in which the spray material is mixed with the washing water and discharged, the raw water control valve V2 may be controlled to open, and the flow control valve 182 may be controlled to switch to the side of the spray nozzle 151, so that the washing water may be introduced into the mixing line 154, and the spray material stored in the storage container 140 may be controlled to be discharged to the mixing line 154 due to raw water pressure. The spray material and the washing water mixed in the mixing line 154 may be discharged to the outside of the toilet bowl 2 or the bidet 1 through the spray nozzle 151.

In another embodiment of the present disclosure, the controller 170 may control the spray material to be discharged through the spray nozzle 151 at a pre-set time, even when user seating is not detected. Thus, it is possible to maintain a clean environment at all times.

When the user leaves the toilet seat 10 after using the toilet, departure from the seat may be detected by the seat sensor S. When departure from the seat is detected, the controller 170 may control the operation of the fan 130. In an embodiment in which a single fan is provided, the controller 170 may control the fan 130 to rotate at a second speed faster than the first speed. In an embodiment in which a plurality of fans is provided, the controller 170 may control a fan having a faster rotation speed to operate or all fans to operate. Thus, the odorous air in the internal space of the toilet bowl 2 may be quickly deodorized and discharged to the outside. Thereafter, the controller 170 may control the fan 130 not to operate.

In another embodiment of the present disclosure, the controller 170 may control the fan 130 to operate at a pre-set time, even when user seating is not detected. Thus, it is possible to maintain a clean environment in the internal space of the toilet bowl 2 at all times.

According to the bidet according to the embodiments of the present disclosure described above, the following effects are achieved.

First, the odorous air in an environment where the bidet is installed is deodorized, and the deodorized air can be provided to a user, so that hygiene and cleanliness can be enhanced.

Second, not only can odorous substances contained in the odorous air be deodorized, but odor-containing, odor-emitting substances can also be together discharged to the outside, so that hygiene and cleanliness can be enhanced, and simultaneously, fragrance is naturally spread into a bathroom space and thus user satisfaction can be increased.

Third, an exhaust port is formed in a location where the air discharged through the exhaust port does not directly contact the user, so that discomfort caused by the user's contact with the discharged air can be minimized.

Fourth, since the bidet is configured to discharge a spray material toward the outside of a toilet bowl or bidet, sterilization inside the toilet bowl and/or sterilization of the environment in which the bidet is installed can be performed, and the bidet is excellent in removing odors.

While the present invention has been particularly shown and described with reference to exemplary embodiments thereof, it will be understood by those of ordinary skill in the art that various changes in form and details may be made therein without departing from the spirit and scope of the present invention as defined by the following claims.

### EXPLANATION OF REFERENCE NUMERALS

F: filter
S: seat sensor
V1: check valve
V2: raw water control valve
1: bidet
2: toilet bowl
10: toilet seat
100: bidet body
101: lower surface
110: intake port
111: first intake port
112: second intake port
120: exhaust port
130: fan
131: first fan
132: second fan
140: storage container
141: inlet
142: stopper
143: discharge port
150: spray material discharging portion
151: spray nozzle
152: pump
153: spray material flow path
154: mixing line
160: flow path
161: first flow path
162: second flow path
170: controller
181: filter unit
182: flow control valve
183: washing unit

1. A bidet comprising:
an intake port and an exhaust port, which are formed in a bidet body;
a filter installed on a flow path between the intake port and the exhaust port;
a fan configured to generate a flow of fluid toward the exhaust port from the intake port;
a storage container of which at least a part is disposed to overlap the flow path and which accommodates a spray material;
a spray material discharging portion configured to discharge the spray material stored in the storage container toward an outside; and
a controller configured to control an operation of the fan and discharging of the spray material through the spray material discharging portion.

2. The bidet of claim 1, wherein the fan is provided with a single unit, and
the controller is configured to control a rotation speed of the fan.

3. The bidet of claim 2, wherein, when user seating is detected, the controller
controls an operation of the spray material discharging portion so that the spray material is discharged toward a toilet bowl.

4. The bidet of claim 2, wherein the controller controls the fan to rotate at a
first rotation speed while user seating is detected, and controls the fan to rotate at a second rotation speed when departure from a seat is detected after user seating, and the second rotation speed is faster than the first rotation speed.

5. The bidet of claim 1, wherein the intake port comprises a first intake port
and a second intake port, which are formed in different positions of the bidet body, and the flow path comprises a first flow path between the first intake port and the exhaust port and a second flow path between the second intake port and the exhaust port, and the fan comprises a first fan installed on the first flow path and a second fan installed on the second flow path.

6. The bidet of claim 5, wherein the first fan and the second fan are fans that
rotate at a constant speed, but the rotation speed of the first fan is slower than the rotation speed of the second fan, and the controller controls the first fan to operate while user seating is detected, and controls only the second fan to operate when departure from a seat is detected after user seating.

7. The bidet of claim 5, wherein the first fan and the second fan are fans that
rotate at a constant speed, but the rotation speed of the first fan is slower than the rotation speed of the second fan, and the controller controls the first fan to operate while user seating is detected, and controls all of the first fan and the second fan when departure from a seat is detected after user seating.

8. The bidet of claim 1, wherein the exhaust port comprises a plurality of
exhaust holes that pass through a lower surface of the bidet body.

9. The bidet of claim 1, wherein the intake port comprises a plurality of intake
holes that pass through a lower surface of the bidet body.

10. The bidet of claim 1, wherein the storage container comprises:
an inlet through which the spray material is introduced into the storage container; and
a stopper, which covers the inlet and is configured to contact the spray material accommodated in the storage container and contain the spray material.

11. The bidet of claim 10, wherein the stopper is disposed to communicate with
the flow path, and as the fan operates, the spray material contained in the stopper is together discharged to an outside through the exhaust port.

12. The bidet of claim 1, wherein the spray material discharging portion comprises:
a spray nozzle; and
a pump provided between the storage container and the nozzle and configured to press the spray material toward the spray nozzle from the storage container.

13. The bidet of claim 1, further comprising a washing unit that provides a fluid
in which raw water flowing in from an outside is pre-treated, as washing water to a user, and the spray material discharging portion comprises:
a spray nozzle; and
a mixing line, which is provided between the storage container and the nozzle and of which at least a part communicates with a raw water inflow line.
